(19) United States
(12) Patent Application Publication
(10) Pub. No.: US 2004/0051397 A1
(43) Pub. Date: Mar. 18, 2004

(54) Intelligent power distribution system with a selectable output voltage

(76) Inventors: Asko Juntunen, Oulu (FI); Markus Karhumaa, Oulu (FI)

Correspondence Address: Davidson Davidson & Kappel, 14th Floor, 485 Seventh Avenue, New York, NY, 10018, US

(21) Appl. No.: 10/450,869

(22) PCT Filed: Dec. 21, 2001
(86) PCT No.: PCT/FI01/01145

(30) Foreign Application Priority Data
Dec. 22, 2000 (FI) 20002833
Jun. 11, 2001 (FI) 20011221

(51) Int. Cl. H02B 1/24

(52) U.S. Cl. 307/130

(57) ABSTRACT

The present invention relates to an intelligent power distribution system capable of operating at a selectable output voltage, the system including a cable (1) with power bus conductors (1a, 1b) and an intelligent node (2) incorporating a controlled current switch (7) via which a power bus conductor is coupled to an output terminal (4) of the node (2) for supplying current to a load under control of the intelligent node (2). The effective value of the intelligent node output voltage is adapted settable by control of timing, or duty cycle, of the ON/OFF pulses of the controlled current switch (7).

The present invention relates to an intelligent power distribution system capable of operating at a selectable output voltage, the system including a cable with power bus conductors and an intelligent node incorporating a controlled current switch via which a power bus conductor is coupled to an output terminal of the node for supplying current to a load under control of the intelligent node.

This kind of power distribution systems are known in the art from, e.g., international patent applications WO 99/25585 and WO 99/25586 filed in the name of the applicant. These publications also contain a more detailed description of the function and construction of such intelligent nodes that are referred to in this text as the state of the art whereon the present invention is based.

The use of 42 V systems in vehicles is becoming more common. The automotive industry will be adopting the 42 V power distribution system within a few years. Initially, however, it must be appreciated that 12 V equipment will exist for years, because it is not technically feasible to change all equipment to the new standard without a transition period of several years. Hence, the battery system of a vehicle must support both the 42 V and 12 V voltages in one and the same vehicle. Additionally, there will exist equipment that need to be supplied at a voltage varying, e.g., from 5 V to 12 V.

Also the 24 V systems being currently used will be converted (slightly later than in personal cars) into 42 V systems, which means that herein a 24 V supply must be provided as an auxiliary voltage over a certain transition period.

It is an object of the invention to provide an intelligent power distribution system of the above-described kind capable of supplying, in parallel with the current source voltage, a selectable output voltage for one or more intelligent nodes of the system.

This object of the invention is achieved by way of the features specified in appended claim 1 or 11. Details of preferred embodiments of the invention are disclosed in the dependent claims.

In the following, an exemplary embodiment of the invention will be explained in greater detail with reference to the appended drawings, in which

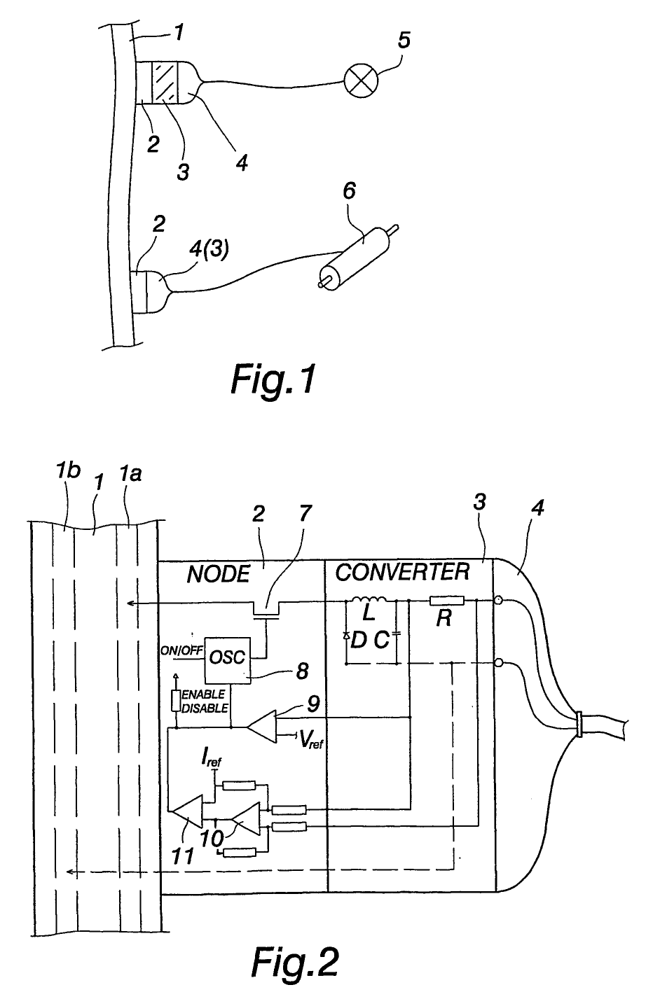

FIG. 1 is a schematic layout of a system in accordance with the invention;

FIG. 2 is an exemplary circuit layout suited for realizing a selectable output voltage in accordance with the invention. Node 2 is outlined only for those special features that are needed in the invention to complement an intelligent node as to its processor, program memory and interface connections implemented with the help of an ASIC, for instance. Concerning these components, reference is made, e.g. to the patent publication WO 99/25586;

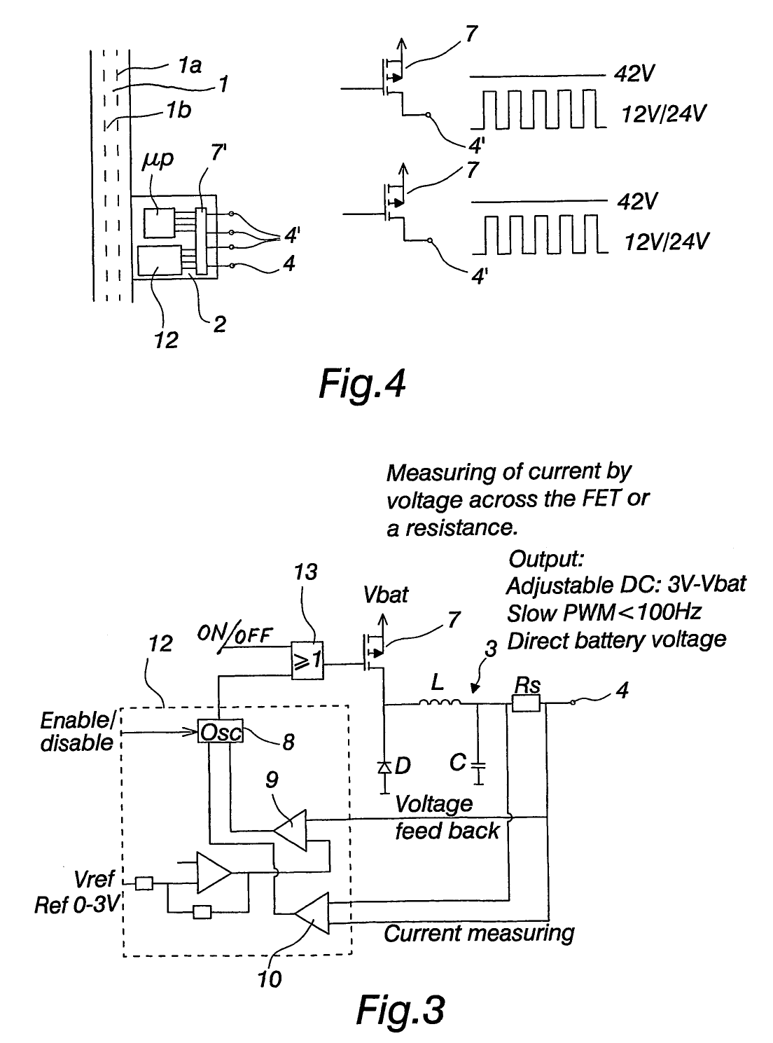

FIG. 3 is an exemplary circuit layout suited for realizing the selectable output voltage in accordance with the invention for an intelligent node; and

FIG. 4 is a schematic system layout of a second exemplary embodiment in accordance with the invention, a more detailed description of which is given, e.g., in the patent publication WO 99/25586.

### EXEMPLARY EMBODIMENT OF FIGS. 1 AND 2

A power distribution system includes a cable 1 carrying supply bus conductors 1a, 1b and having a desired number of intelligent nodes 2 connected thereto. Each node 2 incorporates a controlled current switch 7 (solid-state switch) via which one supply bus conductor 1a is coupled to an output terminal 4 of the node 2 for supplying current to a load 5, 6. The intelligent node 2 controls this supply of current by turning switch 7 into the ON or OFF state according to the control signals received by node 2 either via the control bus of cable 1 or directly via an INPUT line connected to node 2.

An idea realized in the invention was to utilize the controlled current switches 7 of the intelligent node 2 (each node 2 typically housing four switches) also for the purpose of selecting the level of the output voltage. To this end, between the controlled current switch 7 and the output line of the output terminal 4 is connected a converter 3 whose output voltage level is selected by controlling the timing of the ON/OFF pulses of the controlled current switch 7. The converter 3 may be constructed in a conventional fashion around a circuit formed by an inductor L, a capacitor C and a diode D, whereby a pulsed voltage applied to inductor L charges capacitor C and thus brings up the output voltage of converter 3. Once the desired output voltage level is attained, the pulse train is temporarily halted (switch 7 is controlled for a short time into its OFF state). The duration of non-pulsed intervals is set according to the load current and capacitance of capacitor C so that the output voltage does not drop essentially before the start of the next train of pulses.

Alternatively, the duty cycle of switch 7 can be controlled by reducing the width of the pulses when the output voltage or current tends to exceed a desired level. The upper limit of the current and/or the desired voltage level can be made settable under control performed by the intelligent node.

Next, the function of the circuitry is described in more detail with regard to the control of switch 7 as to the above-mentioned output voltage selection and current limiting.

The intelligent node 2 incorporates an oscillator 8 for controlling the timing of the ON/OFF pulses of the switch 7. A voltage comparator 9 controls the operation of oscillator 8 on the basis of a comparison between the output voltage of converter 3 and a reference voltage V_{ref} delivered by the intelligent node 2 so as to set the converter output voltage to a desired value. The circuit configuration of intelligent node 2 and messages received at the node 2 determine the desired output voltage level. This function can be utilized in conjunction with, e.g., compulsory day-around-use of vehicle headlights, whereby it is possible during daylight time to reduce only the supply voltage of the headlights in the system. For such voltage control, the ambient illumination level can be measured by a sensor and the illumination level information is then transmitted to the intelligent nodes 2 that supply current to the headlights. In a similar fashion, it is possible to sense, e.g., the ambient temperature and, if a frost condition is detected, to increase the drive voltage to the motor of a window regulator in order to disengage a window possibly sticking due to frost.

In the embodiment shown, the intelligent node 2 incorporates a two-stage current comparator 10, 11 that controls the operation of oscillator 8 on the basis of a comparison between the output current of converter 3, measured with the help of a current sense resistor R, and a reference current I_{ref} delivered by the intelligent node 2 so that the output current of converter 3 does not exceed a desired or predetermined limit value. This function can be utilized for conventional current limiting of functional components/actuators as well as for limiting the onrush current that occurs when functional components or actuators are switched on.

In the above-described embodiment, the oscillator 8 is provided with an ENABLE/DISABLE input that is common for voltage comparator 9 and current comparator 10, 11. Herein, the selection of the output voltage and current limiting function complement each other so that the output voltage may sink from its set value when current limiting is needed but as soon as the load current no longer exceeds the predetermined limit, the output voltage returns to its set value. This can be accomplished by way of, e.g., inhibiting the control pulse output of oscillator 8 when the output current or voltage of converter 3 tends to exceed its predetermined value. Accordingly, oscillator 8 and switch 7 respectively operate at a given duty cycle until voltage comparator 9 or current comparator 10, 11 respectively inhibits the operation of oscillator 8 for a short pause of pulses during which the controlled current switch 7 stays in the OFF state. An alternative arrangement is to make oscillator 8 to control the duty cycle of switch 7 by way of reducing the width of pulses when the output current or voltage tends to exceed its predetermined value. The pulse frequency of oscillator 8 is selected with respect to the components L, C, such that the inhibit intervals of the pulses are minimized at the normal level of load current, whereby switch 7 is operated at its optimal load and the variations of output voltage are minimized.

Load drive is switched on and off by means of an ON/OFF control signal given to the oscillator from the intelligent node 2.

Converter 3 may be a separate unit connectable between the output terminal 4 and the intelligent node 2, whereby it can be connected as necessary to those intelligent nodes 2 that are desired to supply current to functional components/actuators at a selectable voltage. Alternatively, converter 3 may be designed to be an integral element of output terminal 4.

Exemplary Embodiment of FIGS. 3 and 4

The power distribution system includes a cable 1 carrying supply bus conductors 1a, 1b and having a desired number of intelligent nodes 2 connected thereto. Each node 2 incorporates one or more controlled current switches 7 (solid-state switches of the PMOS or NMOS type) via which one supply bus conductor 1a or 1b is coupled to an output terminal 4 of the node 2 for supplying current to a load. A microprocessor μP of the intelligent node 2 controls this current output by turning switch 7 into the ON or OFF state according to the control signals received by node 2 either via the control bus of cable 1 or directly via an INPUT line connected to node 2.

An idea realized in the invention was to utilize the controlled current switches 7 of the intelligent node 2 (each node 2 typically housing four switches) also for the purpose of selecting the level of output voltage. The level of output voltage is selected by controlling the timing of the ON/OFF pulses of the controlled current switch 7. Thus, all different drive voltages can be realized using a single standardized circuit construction. One or more of the outputs 4 of a single intelligent node 2 can be set to deliver either the system supply voltage (e.g., 42 V) or a pulsed voltage (using PWM) at a low pulse rate of 500 Hz, for instance, whereby the duty cycle is controlled so as to drive the load at a desired effective voltage level.

When a functional component/actuator must be driven at a given DC voltage, this drive power is made available by a single intelligent node 2 offering one or more outputs 4 that is/are capable of delivering either a DC voltage settable in the range of 3 V to Vbat or a PWM voltage of a slow pulse rate (e.g., 500 Hz or smaller, even less than 100 Hz) or, directly, the supply voltage. To deliver a DC voltage at an output terminal 4, the microprocessor μP of the intelligent node 2 triggers a separate local oscillator 8 adapted to operate, e.g., at 100 kHz frequency, and generates a reference voltage V_{ref} against which the output voltage is stabilized by means of voltage feedback from the output terminal.

If it is desirable for an output 4, 4′ to deliver an output voltage directly from the system supply DC voltage bus, the operation of oscillator 8 is inhibited and the system supply DC voltage is thus passed directly via inductor L to output 4. In a similar fashion, if the output terminal is desired to drive the load with a PWM voltage of a slow pulse rate (e.g., 500 Hz), a voltage pulsed at such a low rate will pass the converter 3 unchanged inasmuch the converter 3 is adapted to operate at a much higher frequency. Referring to FIG. 4, outputs 4′ shown therein are taken directly from switch 7 without converter 3. A portion of electrical loads can be driven with a pulsed supply voltage, whereby converter 3 may be omitted or it can be designed to pass a PWM voltage of a low pulse rate.

The converter 3 may be constructed in a conventional fashion around a circuit formed by an inductor L, a capacitor C and a diode D. At low pulse rates (less than 1 kHz, e.g., in the range 50-500 Hz), converter 3 acts as an interference filter. When driven at high pulse rates (e.g., above 5 or 10 kHz, typically at 100 kHz), converter 3 acts as a regulated output voltage source in the following fashion. A pulsed voltage applied to inductor L charges capacitor C and thus brings up the output voltage of converter 3. After the desired output voltage level is attained, the pulse train is temporarily halted (switch 7 is controlled for a short time into its OFF state). The duration of nonpulsed intervals is set according to the load current and capacitance of capacitor C so that the output voltage does not drop essentially before the start of the next train of pulses.

Alternatively, the duty cycle of switch 7 can be controlled by reducing the width of the pulses when the output voltage or current tends to exceed a desired level. The upper limit of current and/or the desired voltage level can be made settable under control performed by the microprocessor of the intelligent node.

The intelligent node 2 incorporates an oscillator 8 for controlling the timing of the ON/OFF pulses of the switch 7. A voltage comparator 9 controls the operation of the oscillator 8 on the basis of a comparison between the voltage sensed at output 4 or 4′ and a reference voltage V_{ref} delivered by the microprocessor μP of intelligent node 2 so as to set the output voltage to a desired value. The configuration of intelligent node 2 and control messages received at the node 2 determine the desired output voltage level.

In the embodiment shown, the intelligent node 2 also incorporates a current comparator 10 that controls the operation of oscillator 8 on the basis of the actual output current measured by sensing the voltage over an output current sense resistor Rₛ so that overload and short-circuit situations can be managed in a proper fashion. As an additional benefit, this function can be utilized for conventional current limiting of functional components/actuators as well as for limiting the onrush current that occurs when functional components or actuators are switched on. In lieu of using a sense resistor Rₛ, the current sense signal may alternatively be obtained by sensing the voltage over the FET switch.

Oscillator 8 is provided with an ENABLE/DISABLE input by means of which the output can be selectably driven either at the settable output voltage (ENABLE) or directly from the vehicle's battery supply voltage (DISABLE). If oscillator 8 is not running, the switch is controlled directly via ON/OFF control input of control block 13. When oscillator 8 is running, switch 7 can be controlled either in combination with the ON/OFF control input or, independently therefrom, by oscillator pulse frequency control and the ENABLE/DISABLE input control.

Accordingly, the invention makes it possible by means of a single unit to provide from a single output terminal or parallel output terminals 4, 4′ of a single intelligent node 2 in a selectable fashion:

1) a DC voltage at system's supply voltage level with an ON/OFF control

2) a settable DC voltage in the range of 3 V to Vbat with an ON/OFF control

3) a settable voltage in a pulse train form (PWM voltage of a slow pulse rate) with an ON/OFF control.

The preferred embodiment shown in FIG. 4 includes one output 4 offering all the three alternatives listed above, as well as one or more outputs 4′ offering alternatives 1) and 3) but lacking the facility of alternative 2) that provides the settable DC output voltage level.

What is claim d is:

1. An intelligent power distribution system capable of operating at a selectable output voltage, the system including a cable (1) with power bus conductors (1a, 1b) and an intelligent node (2) having a configuration and incorporating a controlled current switch (7) via which a power bus conductor (1a) is coupled to an output terminal (4) of the node (2) for supplying current to a load (5, 6) under control of the intelligent node (2), characterized in that between the controlled current switch (7) and an output line of the output terminal (4) is connected a converter (3) whose output voltage level is selectable by controlling the timing of the ON/OFF pulses of the controlled current switch (7), and the desired output voltage level is determined by the configuration of the intelligent node (2) and by messages received at the node (2).

2. The system of claim 1, characterized in that the intelligent node (2) incorporates an oscillator (8) for controlling the timing of the ON/OFF pulses of the controlled current switch (7) and a voltage comparator (9) for controlling the operation of the oscillator (8) on the basis of a comparison between the output voltage of the converter (3) and a reference voltage delivered by the intelligent node (2) so as to set the converter output voltage to a desired value.

3. The system of claim 2, characterized in that the intelligent node (2) incorporates a current comparator (10, 11) for controlling the operation of the oscillator (8) on the basis of a comparison between the output current measured at the output of converter (3) and a reference current delivered by the intelligent node so that the output current of the converter (3) does not exceed a desired limit value.

4. The system of claim 3, characterized in that the oscillator (8) is provided with an ENABLE/DISABLE input that is configured common for both the voltage comparator (9) and the current comparator (10, 11) and is capable of inhibiting the control pulse output of the oscillator (8) when the output current or voltage of the converter (3) tends to exceed its predetermined value.

5. The system of any one of the claims 2-4, characterized in that the oscillator (8) and the switch (7) respectively operate at a given duty cycle until the voltage or current comparator (9; 10, 11) inhibits the operation of the oscillator (8) for a short pause of pulses during which the controlled switch (7) stays in the OFF state.

6. The system of any one of the claims 2-4, characterized in that the oscillator (8) is adapted to control the duty cycle of the controlled current switch (7) by way of reducing the width of the pulses when the output current or voltage of the converter (3) tends to exceed its predetermined value.

7. The system of any one of claims 1-6, characterized in that the output voltage level and current limit level of the converter (3) are adapted selectable under control of the intelligent node (2).

8. The system of any one of the claims 1-7 having a power bus conductor (1a, 1b) operating at 42 VDC nominal voltage, characterized in that the output voltage level of the converter (3) is selected to be 12 VDC or 24 VDC.

9. The system of any one of the claims 1-8, characterized in that the converter (3) is designed to be a separate unit connectable between the intelligent node (2) and the output terminal (4).

10. The system of any one of the claims 1-8, characterized in that the converter (3) is designed to be an integral element of the output terminal (4).

11. An intelligent power distribution system capable of operating at a selectable output voltage, the system including a cable (1) with power bus conductors (1a, 1b) and an intelligent node (2) having a configuration and incorporating a controlled current switch (7) via which a power bus conductor is coupled to an output terminal (4) of the node (2) for supplying current to a load under control of the Intelligent node (2), characterized in that the effective value of the intelligent node output voltage is adapted settable by control of timing, or duty cycle, of the ON/OFF pulses of the controlled current switch (7) and the desired output voltage level is determined by the configuration of the intelligent node (2) and by messages received at the node (2).

12. The system of claim 11, characterized in that the intelligent node (2) incorporates an oscillator (8) for controlling the timing of the ON/OFF pulses of the controlled current switch (7).

13. The system of claim 12, characterized in that a microprocessor incorporated in the intelligent node triggers an oscillator (8) adapted to operate at a frequency substantially higher than the pulse frequency of the ON/OFF pulses of the switch (7) controlled by the microprocessor.

14. The system of claim 12 or 13, characterized in that the microprocessor of the intelligent node provides a reference voltage (V_{ref}) that in cooperation with the output voltage feedback circuit regulates the output voltage to the level of the selectable reference voltage (V_{ref}).

15. The system of claim 14, characterized in that the selectable regulating control voltage based on the set value of the node output voltage and the function of the feedback circuit controls the operation of the oscillator (8).

16. The system of any one of the claims 11-15, characterized in that the operation of the oscillator (8) is inhibited when a DC voltage from the system power bus or a DC voltage pulsed at a slow rate is to be used for driving a load.

17. The system of any one of the claims 11-15, characterized in that a PWM voltage of a slow pulse frequency is made available at the output terminal (4).

18. The system of any one of the claims 11-17, characterized in that the load current situation is monitored at any one of the selectable output voltage levels and a response is triggered under an overload or short-circuit situation.

19. The system of any one of the claims 11-18, characterized in that at least one output terminal (4) of the intelligent node (2) is adapted capable of delivering a settable DC voltage and at least one other output terminal is adapted capable of delivering a pulsed voltage.

20. The system of claim 19, characterized in that the output terminal (4) adapted capable of delivering a settable DC voltage is also capable of delivering a settable pulsed voltage with low frequency.
